(19) United States
(12) Patent Application Publication
(10) Pub. No.: US 2017/0248890 A1
(43) Pub. Date: Aug. 31, 2017

(54) CONTINUOUS SHEET TRANSPORT DEVICE AND IMAGE FORMING APPARATUS

(71) Applicant: FUJI XEROX CO., LTD., Tokyo (JP)

(72) Inventor: Mitsuhiro MORI, Ebina-shi (JP)

(73) Assignee: FUJI XEROX CO., LTD., Tokyo (JP)

(21) Appl. No.: 15/244,994

(22) Filed: Aug. 23, 2016

(30) Foreign Application Priority Data
Feb. 26, 2016 (JP) 2016-035397

(51) Int. Cl. G03G 15/00; B65H 20/20

(52) U.S. Cl. CPC G03G 15/6517; B65H 20/20

(57) ABSTRACT

A continuous sheet transport device transports a continuous sheet along a sheet transport path passing through a transfer position at which a toner image is transferred. The device includes a first transport unit that is provided on an upstream side of the transfer position on the sheet transport path and transports the continuous sheet, a sheet feeding unit that is provided on an upstream side of the first transport unit on the sheet transport path and that feeds the continuous sheet, a leasing end of which is placed on the sheet feeding unit, toward a downstream side on the sheet transport path, and an operation controller that controls the first transport unit to temporarily operate in a reverse transport direction so that the continuous sheet is transported to the upstream side at a timing before the leading end of the continuous sheet reaches the first transport unit.

### CROSS-REFERENCE TO RELATED APPLICATIONS

This application is based on and claims priority under 35 USC 119 from Japanese Patent Application No. 2016-035397 filed Feb. 26, 2016.

### BACKGROUND

1. Technical Field

The present invention relates to a continuous sheet transport device and an image forming apparatus.

2. Related Art

A printer for printing an image on long continuous sheet such as continuous form sheet is known. Sheet jam is less likely to occur in a printer using continuous sheet as compared to a printer using cut sheet such as A4 size sheet, for example. Even so, it cannot be said that sheet jam never occurs in the printer using the continuous sheet. The sheet jam sometimes occurs in the printer using the continuous sheet. Once a sheet jam occurs in the printer using continuous sheet, the recovery of the printer is not easy. Any piece of sheet or the like should be removed from all the portions of the printer so that a torn piece of sheet or the like does not remain in the printer and then the transportation of the continuous sheet is to be resumed. In a case where the torn piece of sheet or the like is not completely removed from the printer by a user due to not seeing the torn piece of sheet or the like, when the sheet jam is generated again, the recovery of the printer is further delayed.

### SUMMARY

An aspect of the present invention provides a continuous sheet transport device that transports a continuous sheet along a sheet transport path passing through a transfer position at which a toner image is transferred. The continuous sheet transport device includes a first transport unit that is provided on an upstream side of the transfer position on the sheet transport path and transports the continuous sheet, a sheet feeding unit that is provided on an upstream side of the first transport unit on the sheet transport path and that feeds the continuous sheet, a leasing end of which is placed on the sheet feeding unit, toward a downstream side on the sheet transport path; and an operation controller that controls the first transport unit to temporarily operate in a reverse transport direction so that the continuous sheet is transported to the upstream side at a timing before the leading end of the continuous sheet reaches the first transport unit.

### BRIEF DESCRIPTION OF THE DRAWINGS

Exemplary embodiments of the present invention will be described in detail based on the following figures, wherein:

FIG. 1 is a schematic view illustrating a configuration of a continuous form printer as an exemplary embodiment of an image forming apparatus of the present invention; and

FIG. 2 is a diagram illustrating process at the time of sheet passing operation.

### DETAILED DESCRIPTION

Hereinafter, an exemplary embodiment of the present invention will be described.

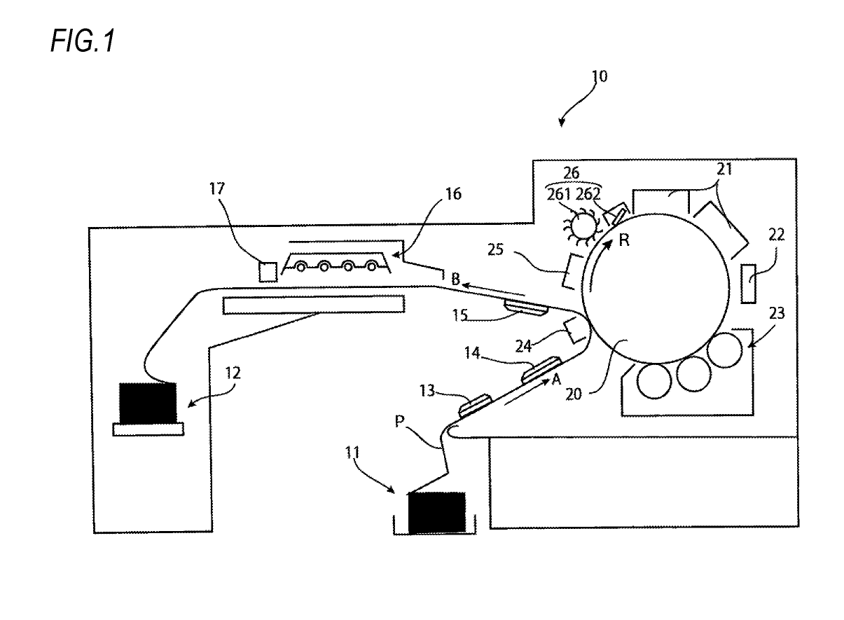

FIG. 1 is a schematic view illustrating a configuration of a continuous form printer as an exemplary embodiment of an image forming apparatus of the present invention.

A folded sheet P is housed in a sheet hopper 11. The sheet P housed in the sheet hopper 11 is transported in the direction of an arrow A by a pre-tractor 13 and an upstream side tractor 14, is passed through a transfer position facing a photoconductor 20, is further transported in the direction of an arrow B by a downstream side tractor 15, is passed through a flash fixing device 16, and is housed in a sheet stacker 12 so as to be folded.

The photoconductor 20 has a drum shape and rotates in a direction of an arrow R. A charging device 21, a light exposing device 22, and a developing device 23 is disposed around the photoconductor 20. A toner image is formed on the photoconductor 20 by a process of charging, light exposure, and development. The toner image formed on the photoconductor 20 is transferred to the sheet P by a transfer device 24.

The photoconductor 20 after the transfer eliminates the charge by a charge eliminating device 25. Further, the photoconductor 20 is cleaned by a cleaner 26 having a cleaning brush 261 and a cleaning blade 262.

The toner image transferred to the sheet P proceeds to the flash fixing device 16 as the transport of the sheet P, receives illumination of flash light by the flash fixing device 16, and thus is fixed to the sheet P. Scattered toners and fine sheet dust which are generated at the time of emitting light of the flash by the flash fixing device 16 are suctioned by a suction device 17. Subsequently, the sheet P is housed in the sheet stacker 12.

The continuous form printer 10 includes a controller 30. The operations described above are performed under control by the controller 30.

Here, it is assumed that a sheet jam is generated at the continuous form printer 10.

When the sheet jam is generated, the sheet is torn, and thus there is a possibility that the torn sheet remains in various places along the sheet transport path of the continuous form printer 10. In particular, the torn sheet is likely to remain in the tractor of which the path of the sheet is narrow. An operator has to carefully remove from the printer all the pieces of the sheet generated by being torn of the sheet and then pass the sheet through the printer again. However, there is a possibility that the sheet passing operation is performed in a state where some pieces of the sheet remain in the tractors due to a checking mistake. In this case, there is high concern about the reoccurrence of the sheet jam. Here, in this exemplary embodiment, at the time of the sheet passing operation, the process to be described below are performed.

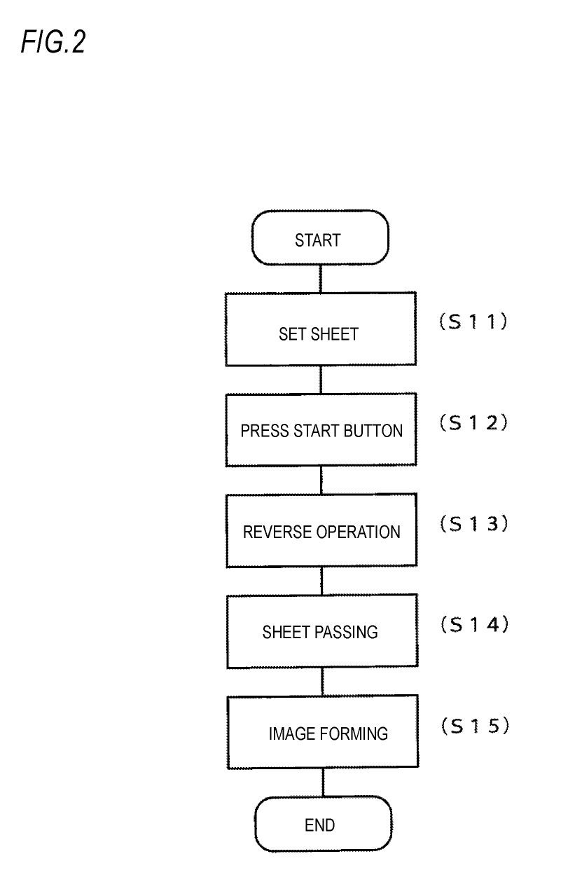

FIG. 2 is a diagram illustrating processes at the time of sheet passing operation.

When sheet passing operation is performed, first, a leading end portion of the sheet P housed in the sheet hopper 11 is set to the pre-tractor 13 (step S11).

After setting of the sheet P, a start button (not illustrated) instructing the sheet passing operation is pressed (step S12).

In the continuous form printer 10 according to the present exemplary embodiment, even if the start button is pressed, the sheet passing operation is not immediately performed, first, the upstream side tractor 14 performs a reverse operation for a predetermined time period. The reverse operation referred to herein is an operation which transports sheet P in the direction opposite to the direction of the arrow A of the sheet P if the sheet P were passed through the upstream side tractor 14.

In a case where a piece of the sheet remains in the upstream side tractor 14, the remaining piece of the sheet is separated from the upstream side tractor 14 and thus is dropped due to this reverse operation. Therefore, the occurrence of a new sheet jam by the remaining piece of the sheet P is prevented in advance.

When the reverse operation of the upstream side tractor 14 is terminated, all the transport members such as the pre-tractor 13, the upstream side tractor 14 and the downstream side tractor 15 are operated in the forward direction and thus the sheet passing operation is performed. The sheet P is passed through the normal transport path and thus the leading end of the sheet P reaches the sheet stacker 12 (step S14).

Subsequently, the image forming on the sheet P is performed by the process described above (step S15).

Here, in step S13 in FIG. 2, it is described that the upstream side tractor 14 performs the reverse operation, there are several modes related to the operation of the downstream side tractor 15.

In the continuous form printer 10, the transfer of the toner image at the transfer position from the photoconductor 20 to the sheet P is one of major factors for forming an image on the sheet P in good quality, even if there is no effect to the sheet passing operation, the piece of the sheet or the sheet dust existing in the vicinity of the transfer position is not preferable. On the other hand, a possibility that the piece of the sheet remains in the downstream side tractor 15 cannot be denied.

Accordingly, in a structure in which there is no effect in the transfer position even if the downstream side tractor 15 is reversely operated and the piece of the sheet is pushed out in the direction from the downstream side tractor 15 toward the transfer position side by the reverse operation, the reverse operation of the upstream side tractor 14 and the reverse operation of the downstream side tractor 15 are preferably performed at the same time in step S13 in FIG. 2. In this case, a driving mechanism of a simple structure which always operates the upstream side tractor 14 and the downstream side tractor 15 in the same direction may be included.

Alternatively, in a structure that may adversely affect the transfer of the toner image at the transfer position if the downstream side tractor 15 performs the reverse operation and thus the piece of the sheet is pushed out toward the transfer position side, the downstream side tractor 15 during reverse operation of the upstream side tractor 14 may be stopped. Alternatively, during the reverse operation of the upstream side tractor 14, the forward operation in the downstream side tractor 15 may be performed. The forward operation of the tractor is performed even at the time of the sheet passing operation, but there is a high possibility that the remaining piece of the sheet is pushed out on the forward operation side by the forward operation being performed in advance.

Furthermore, there will be considered below a case where the driving mechanism of the tractors is further simplified and all of the pre-tractor 13, the upstream side tractor 14 and the downstream side tractor 15 are operated in the forward direction at the same time or are operated in the rearward direction at the same time.

In this case, when the sheet P is set to the pre-tractor 13 and then the upstream side tractor 14 is operated in the rearward direction, the pre-tractor 13 is also operated in the rearward direction and thus the set sheet comes off from the pre-tractor 13. Therefore, in this case, the operation illustrated in FIG. 2 cannot be employed. Accordingly, in this case, a reverse operation button which instructs a reverse operation of the tractor may be provided in addition to the start button which instructs the sheet passing operation. Then, it may be configured that the operation of the start button is not performed unless the reverse operation button is pressed and then the tractors perform the reverse operation for a predetermined time period. By doing so, an operator presses the reverse operation button and thus causes the tractor to operate in the reverse direction before the sheet P is set to the pre-tractor 13. When the reverse operation is stopped, the operator sets the sheet P to the pre-tractor 13 and then presses the start button. Accordingly, the reverse operation of the tractor is performed and then the sheet passing operation can be performed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A continuous sheet transport device that transports a continuous sheet along a sheet transport path passing through a transfer position at which a toner image is transferred, the device comprising:
a first transport unit that is provided on an upstream side of the transfer position on the sheet transport path and transports the continuous sheet;
a sheet feeding unit that is provided on an upstream side of the first transport unit on the sheet transport path and that feeds the continuous sheet, a leasing end of which is placed on the sheet feeding unit, toward a downstream side on the sheet transport path; and
an operation controller that controls the first transport unit to temporarily operate in a reverse transport direction so that the continuous sheet is transported to the upstream side at a timing before the leading end of the continuous sheet reaches the first transport unit.

2. The continuous sheet transport device according to claim 1,
wherein the continuous sheet is formed with holes for transport on both side portions thereof at predetermined intervals, and
wherein the first transport unit includes a tractor that transports the continuous sheet by rotating while inserting pins in the holes on the both side portions of the continuous sheet.

3. The continuous sheet transport device according to claim 1, further comprising:
a second transport unit that is provided on a downstream side of the transfer position on the sheet transport path and transports the continuous sheet,
wherein when the operation controller controls the first transport unit to operate in the reverse transport direction at the timing before the leading end of the continuous sheet reaches the first transport unit, the operation controller controls the first transport unit to operate in the reverse transport direction without controlling the second transport unit to operate in the reverse transport direction.

4. The continuous sheet transport device according to claim 2, further comprising:
a second transport unit that is provided on a downstream side of the transfer position on the sheet transport path and transports the continuous sheet,
wherein when the operation controller controls the first transport unit to operate in the reverse transport direction at the timing before the leading end of the continuous sheet reaches the first transport unit, the operation controller controls the first transport unit to operate in the reverse transport direction without controlling the second transport unit to operate in the reverse transport direction.

5. An image forming apparatus comprising:
the continuous sheet transport device according to claim 1;
an image forming unit that forms a toner image and transfers the toner image on the continuous sheet at the transfer position; and
an image fixing unit that fixes the toner image transferred on the continuous sheet, on the continuous sheet.
